(19) United States
(12) Patent Application Publication
(10) Pub. No.: US 2017/0220952 A1
(43) Pub. Date: Aug. 3, 2017

(54) INTELLIGENT SELECTION AND CLASSIFICATION OF ORACLES FOR TRAINING A CORPUS OF A PREDICTIVE COGNITIVE SYSTEM

(71) Applicant: International Business Machines Corporation, Armonk, NY (US)

(72) Inventors: Aaron K. Baughman, Silver Spring, MD (US); Gary F. Diamanti, Wake Forest, NC (US); Mauro Marzorati, Lutz, FL (US)

(21) Appl. No.: 15/014,085

(22) Filed: Feb. 3, 2016

(51) Int. Cl. G06N 99/00; G06F 17/30

(52) U.S. Cl. CPC G06N 99/005; G06F 17/30705

(57) ABSTRACT

A method and systems for intelligent selection and classification of oracles used to train a predictive cognitive system. A computerized oracle-selection system identifies candidate “oracle” experts in a field of endeavor known as a domain. The system retrieves contemporaneous natural-language “artifact” documents that each refer to or were produced by an oracle, and contains information from which may be predicted a future event related to the domain. The system assigns each oracle a confidence factor that identifies the accuracy of that oracle's predictions, and ranks the artifacts by how closely each matches the domain and by the confidence factors of its associated oracles. The artifacts are merged into the corpus, where the rankings indicate which artifacts may most reliably be used by the cognitive system to formulate predictive responses to user queries. This procedure is repeated each time the system receives user feedback or an updated set of artifacts.

### TECHNICAL FIELD

This invention relates to improving the functioning of a predictive cognitive system by more efficiently and accurately training a corpus used by the system to infer predictions of future events.

### BACKGROUND

Predictive natural-language processing systems and other types of artificially intelligent systems require training in order to reliably predict future events in response to user input. Such training comprises building a specialized body of information (known as a “corpus”) from which the system may infer rules for interpreting and responding to unstructured natural-language user input.

Training a predictive system may involve a continuous process of refining information and logic stored in a corpus to reduce biases, questionable assumptions, factual inaccuracies, and other flaws that render the corpus less reliable. Designers attempt to minimize the time and effort required by such refining by initially populating a corpus with information culled from sources (known as “oracles”) that have demonstrated an ability to make accurate predictions.

There is no way, however, to automatically identify and rank oracles by their reliability, nor to automatically classify and rank information associated with a particular. There is thus a need for a way to automatically identify the most reliable oracles and to use those identifications to populate and continuously update a corpus such that it can be used to most efficiently train a predictive system to make accurate predictions.

### BRIEF SUMMARY

A first embodiment of the present invention provides an oracle-selection system comprising a processor, a memory coupled to the processor, and a computer-readable hardware storage device coupled to the processor, the storage device containing program code configured to be run by the processor via the memory to implement a method for intelligent selection and classification of oracles, the method comprising:

the selection system identifying a set of candidate oracles, where each oracle of the set of candidate oracles is a human or computerized expert in a field of endeavor identified by a domain of a corpus of a cognitive system;

the selection system retrieving a set of artifacts from remote sources, where each artifact of the set of artifacts is associated with an oracle of the set of oracles, and where the retrieving is performed by a set of concurrent procedures that retrieve artifacts at a substantially similar time;

the selection system associating a subset of the retrieved artifacts with the domain, where the domain identifies a topic of each artifact of the subset;

the selection system assigning a confidence factor of a set of confidence factors to each oracle of the set of oracles, where a higher confidence factor assigned to a first oracle identifies a greater presumed degree of reliability of one or more predictions made by the first oracle within the field of endeavor;

the selection system ranking the subset of artifacts, where a higher-ranking artifact of the subset is deemed to have more significance to the cognitive system than does a lower-ranking artifact of the subset; and

the selection system merging the artifacts into the corpus.

A second embodiment of the present invention provides a method for intelligent selection and classification of oracles, the method comprising:

a computerized oracle-selection system identifying a set of candidate oracles, where each oracle of the set of candidate oracles is a human or computerized expert in a field of endeavor identified by a domain of a corpus of a cognitive system;

the selection system retrieving a set of artifacts from remote sources, where each artifact of the set of artifacts is associated with an oracle of the set of oracles, and where the retrieving is performed by a set of concurrent procedures that retrieve artifacts at a substantially similar time;

the selection system associating a subset of the retrieved artifacts with the domain, where the domain identifies a topic of each artifact of the subset;

the selection system assigning a confidence factor of a set of confidence factors to each oracle of the set of oracles, where a higher confidence factor assigned to a first oracle identifies a greater presumed degree of reliability of one or more predictions made by the first oracle within the field of endeavor;

the selection system ranking the subset of artifacts, where a higher-ranking artifact of the subset is deemed to have more significance to the cognitive system than does a lower-ranking artifact of the subset; and

the selection system merging the artifacts into the corpus.

A third embodiment of the present invention provides a computer program product, comprising a computer-readable hardware storage device having a computer-readable program code stored therein, the program code configured to be executed by an oracle-selection system comprising a processor, a memory coupled to the processor, and a computer-readable hardware storage device coupled to the processor, the storage device containing program code configured to be run by the processor via the memory to implement a method for intelligent selection and classification of oracles, the method comprising:

the selection system identifying a set of candidate oracles, where each oracle of the set of candidate oracles is a human or computerized expert in a field of endeavor identified by a domain of a corpus of a cognitive system;

the selection system retrieving a set of artifacts from remote sources, where each artifact of the set of artifacts is associated with an oracle of the set of oracles, and where the retrieving is performed by a set of concurrent procedures that retrieve artifacts at a substantially similar time;

the selection system associating a subset of the retrieved artifacts with the domain, where the domain identifies a topic of each artifact of the subset;

the selection system assigning a confidence factor of a set of confidence factors to each oracle of the set of oracles, where a higher confidence factor assigned to a first oracle identifies a greater presumed degree of reliability of one or more predictions made by the first oracle within the field of endeavor;

the selection system ranking the subset of artifacts, where a higher-ranking artifact of the subset is deemed to have more significance to the cognitive system than does a lower-ranking artifact of the subset; and

the selection system merging the artifacts into the corpus.

### BRIEF DESCRIPTION OF THE DRAWINGS

FIG. 1 shows a structure of a computer system and computer program code that may be used to implement a method for intelligent selection and classification of oracles in accordance with embodiments of the present invention.

FIG. 2 is a flow chart that illustrates a method for intelligent selection and classification of oracles in accordance with embodiments of the present invention.

### DETAILED DESCRIPTION

Natural-language processing systems and other types of artificially intelligent or software must be trained in order to learn how to interact with users in a manner that simulates natural human interaction. Such systems may be referred to as being “cognitive” because, when properly trained, their interactions with users suggest cognitive processes of human beings.

Predictive cognitive systems attempt to predict future events in response to natural-language user input. If, for example, a user enters a free-form question “Will it rain in Memphis tomorrow?” an artificially intelligent predictive system might respond by retrieving and analyzing “artifact” elements of (generally unstructured or natural-language) information stored in its “corpus” repository of data and logic. By selecting artifacts most likely to be reliable and relevant to the user's query, the system may then respond with a weather prediction that stands a best chance of being appropriate and correct.

In real-world implementations, this procedure may be complex and a cognitive system may comprise many corpora that each organize into complex data structures large volumes of predictive information, inferential logic, examples, rules, and data relationships.

In such cases, the system's likelihood of responding with an accurate prediction depends upon the quality of information stored in its corpus. Because it would be difficult to initially populate a corpus with completely accurate predictive data and logic, system developers often can seed a new corpus with only their best guesses. Although inefficient, this method may allow a cognitive system to fine-tune its corpora over time by continuing to add artifacts and by keeping track of how reliably specific artifacts help the system to make accurate predictions.

Embodiments of the present invention streamline this procedure by automatically selecting the best sources of information to store in a corpus, by classifying, weighting, and ranking each element of information, by assigning confidence factors to each source, and by then continuing to refine those classifications and rankings over time, as new information is collected and as the system continues to monitor the accuracy of its predictions. In this way, the present invention trains a cognitive system more efficiently and reliably than do current ad hoc methods, allowing the system to more quickly become able to predict future events with confidence.

Embodiments of the present invention may populate one or more corpora with artifacts and may associate each artifact with one or more expert “oracle” sources. Each oracle and each artifact associated with that oracle may be further classified by one or more fields of interest or “domains.” In some embodiments, a domain may in turn comprise two or more sub-domains. In addition, each cognitive system, corpus, oracle, domain, and artifact may be further characterized by a “precision” that identifies a desired level of detail.

In the exemplary weather-predicting system described above, the cognitive system might be associated with a domain of“meteorology.” The system may comprise a corpus that stores artifacts from which may be extracted past weather predictions. These artifacts may have been retrieved from past publications of oracles that include the National Oceanic and Atmospheric Administration, local and national television stations, and the National Weather Service. Each of these oracles may be associated with a “meteorology” domain and, in some cases, with other domains that identify the oracle's geographical scope and the frequency with which the oracle publishes its weather predictions.

Here, the user query requests a weather prediction that should have a precision of “daily,” rather than hourly, weekly, or long-term, and in response, the system initially seeks the most relevant artifacts that have a similar precision (or perhaps greater) precision. Similarly, because the user requests information related to Memphis weather, the most relevant of the artifacts may be those that have domains of “meteorology,” “Memphis,” and “southwestern Tennessee.”

Embodiments of the present invention also assign a confidence factor to each oracle for each domain with which the oracle or the oracle's artifacts may be associated. Consider, for example, a case in which stored artifacts retrieved from a local weather service oracle predict Memphis weather more accurately than do artifacts retrieved from a national weather service oracle that provides only state-wide weather forecasts. In such a case, the embodiment might assign the local service a higher confidence factor than the national service when responding to user input associated with a domain “Memphis weather.”

But if a user query seeks a prediction of California weather, an embodiment might associate that query with a domain “California weather” and then assign the national weather service a higher confidence factor if corpus artifacts (that is, previous weather predictions) demonstrate that the national service more accurately predicts California weather than does the local service.

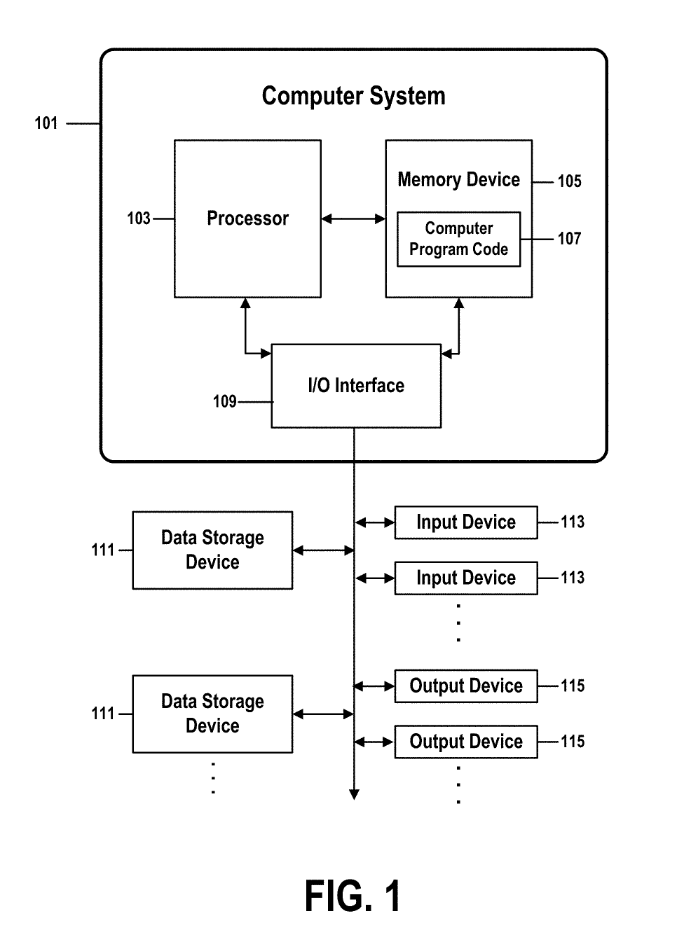

FIG. 1 shows a structure of a computer system and computer program code that may be used to implement a method for intelligent selection and classification of oracles in accordance with embodiments of the present invention. FIG. 1 refers to objects 101-115.

Aspects of the present invention may take the form of an entirely hardware embodiment, an entirely software embodiment (including firmware, resident software, microcode, etc.) or an embodiment combining software and hardware aspects that may all generally be referred to herein as a “circuit,” “module,” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In FIG. 1, computer system 101 comprises a processor 103 coupled through one or more I/O Interfaces 109 to one or more hardware data storage devices 111 and one or more I/O devices 113 and 115.

Hardware data storage devices 111 may include, but are not limited to, magnetic tape drives, fixed or removable hard disks, optical discs, storage-equipped mobile devices, and solid-state random-access or read-only storage devices. I/O devices may comprise, but are not limited to: input devices 113, such as keyboards, scanners, handheld telecommunications devices, touch-sensitive displays, tablets, biometric readers, joysticks, trackballs, or computer mice; and output devices 115, which may comprise, but are not limited to printers, plotters, tablets, mobile telephones, displays, or sound-producing devices. Data storage devices 111, input devices 113, and output devices 115 may be located either locally or at remote sites from which they are connected to I/O Interface 109 through a network interface.

Processor 103 may also be connected to one or more memory devices 105, which may include, but are not limited to, Dynamic RAM (DRAM), Static RAM (SRAM), Programmable Read-Only Memory (PROM), Field-Programmable Gate Arrays (FPGA), Secure Digital memory cards, SIM cards, or other types of memory devices.

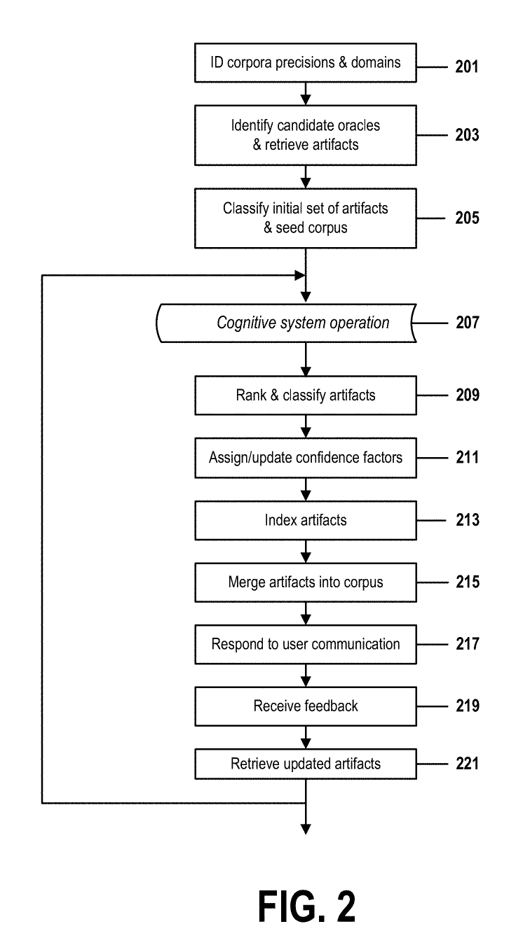

At least one memory device 105 contains stored computer program code 107, which is a computer program that comprises computer-executable instructions. The stored computer program code includes a program that implements a method for intelligent selection and classification of oracles in accordance with embodiments of the present invention, and may implement other embodiments described in this specification, including the methods illustrated in FIGS. 1-2. The data storage devices 111 may store the computer program code 107. Computer program code 107 stored in the storage devices 111 is configured to be executed by processor 103 via the memory devices 105. Processor 103 executes the stored computer program code 107.

In some embodiments, rather than being stored and accessed from a hard drive, optical disc or other writeable, rewriteable, or removable hardware data-storage device 111, stored computer program code 107 may be stored on a static, nonremovable, read-only storage medium such as a Read-Only Memory (ROM) device 105, or may be accessed by processor 103 directly from such a static, nonremovable, read-only medium 105. Similarly, in some embodiments, stored computer program code 107 may be stored as computer-readable firmware 105, or may be accessed by processor 103 directly from such firmware 105, rather than from a more dynamic or removable hardware data-storage device 111, such as a hard drive or optical disc.

Thus the present invention discloses a process for supporting computer infrastructure, integrating, hosting, maintaining, and deploying computer-readable code into the computer system 101, wherein the code in combination with the computer system 101 is capable of performing a method for intelligent selection and classification of oracles.

Any of the components of the present invention could be created, integrated, hosted, maintained, deployed, managed, serviced, supported, etc. by a service provider who offers to facilitate a method for intelligent selection and classification of oracles. Thus the present invention discloses a process for deploying or integrating computing infrastructure, comprising integrating computer-readable code into the computer system 101, wherein the code in combination with the computer system 101 is capable of performing a method for intelligent selection and classification of oracles.

One or more data storage units 111 (or one or more additional memory devices not shown in FIG. 1) may be used as a computer-readable hardware storage device having a computer-readable program embodied therein and/or having other data stored therein, wherein the computer-readable program comprises stored computer program code 107. Generally, a computer program product (or, alternatively, an article of manufacture) of computer system 101 may comprise the computer-readable hardware storage device.

While it is understood that program code 107 for forecastable supervised labels and corpus sets for training a natural-language processing system may be deployed by manually loading the program code 107 directly into client, server, and proxy computers (not shown) by loading the program code 107 into a computer-readable storage medium (e.g., computer data storage device 111), program code 107 may also be automatically or semi-automatically deployed into computer system 101 by sending program code 107 to a central server (e.g., computer system 101) or to a group of central servers. Program code 107 may then be downloaded into client computers (not shown) that will execute program code 107.

Alternatively, program code 107 may be sent directly to the client computer via e-mail. Program code 107 may then either be detached to a directory on the client computer or loaded into a directory on the client computer by an e-mail option that selects a program that detaches program code 107 into the directory.

Another alternative is to send program code 107 directly to a directory on the client computer hard drive. If proxy servers are configured, the process selects the proxy server code, determines on which computers to place the proxy servers' code, transmits the proxy server code, and then installs the proxy server code on the proxy computer. Program code 107 is then transmitted to the proxy server and stored on the proxy server.

In one embodiment, program code 107 data is integrated into a client, server and network environment by providing for program code 107 to coexist with software applications (not shown), operating systems (not shown) and network operating systems software (not shown) and then installing program code 107 on the clients and servers in the environment where program code 107 will function.

The first step of the aforementioned integration of code included in program code 107 is to identify any software on the clients and servers, including the network operating system (not shown), where program code 107 will be deployed that are required by program code 107 or that work in conjunction with program code 107. This identified software includes the network operating system, where the network operating system comprises software that enhances a basic operating system by adding networking features. Next, the software applications and version numbers are identified and compared to a list of software applications and correct version numbers that have been tested to work with program code 107. A software application that is missing or that does not match a correct version number is upgraded to the correct version.

A program instruction that passes parameters from program code 107 to a software application is checked to ensure that the instruction's parameter list matches a parameter list required by the program code 107. Conversely, a parameter passed by the software application to program code 107 is checked to ensure that the parameter matches a parameter required by program code 107. The client and server operating systems, including the network operating systems, are identified and compared to a list of operating systems, version numbers, and network software programs that have been tested to work with program code 107. An operating system, version number, or network software program that does not match an entry of the list of tested operating systems and version numbers is upgraded to the listed level on the client computers and upgraded to the listed level on the server computers.

After ensuring that the software, where program code 107 is to be deployed, is at a correct version level that has been tested to work with program code 107, the integration is completed by installing program code 107 on the clients and servers.

Embodiments of the present invention may be implemented as a method performed by a processor of a computer system, as a computer program product, as a computer system, or as a processor-performed process or service for supporting computer infrastructure.

FIG. 2 is a flow chart that illustrates a method for intelligent selection and classification of oracles in accordance with embodiments of the present invention. FIG. 2 comprises steps 201-221

In step 201, an oracle-selection system initiates a procedure for automatically selecting oracles associated with artifacts that could be used to populate one or more corpora of a predictive cognitive system.

The selection system begins this procedure by identifying a precision and one or more domains of each corpus comprised by the cognitive system. This step may be performed by any means known in the art. In some cases, the selection system may identify a precision and one or more domains of each corpus by reading information that had been recorded by the cognitive system's designers or implementers. In other implementations, this information may be manually submitted to the selection system by an expert familiar with the cognitive system. In yet other embodiments, the selection system may infer a precision and domains by analyzing elements of the cognitive system or its corpora or by analyzing documents that describe aspects of the cognitive system by means of known technologies such as inferential analytics.

Regardless of the method by which this step is performed, the resulting identifications of precisions and domains will be used by the selection system in later steps of FIG. 2 to better select and characterize oracles and artifacts of those oracles that best match requirements of the cognitive system and of its interactions with users.

In one example, a cognitive system intended to predict answers to questions about automobile restoration may comprise two corpora. A first corpus of these two corpora would store information and logic related to procedural tasks related to restoration and might comprise several dozen smaller corpora, each characterized by one or more domains that characterize the smaller corpus's content. These sub-corpora might, for example, each be associated with one or more domains “car restoration,” “hobbies,” “vintage automobiles,” or “mechanical work.” The parent domain might then be associated with a general domain of “restoration tasks” and with a subset of the domains associated with each of its sub-corpora.

In this example, the cognitive system comprises a second corpus that stores artifacts related to a cost associated with various restoration tasks. This second corpus might be associated with a domain “restoration costs” and with other domains that are associated with sub-corpora of the second corpus.

Each corpus or sub-corpus might be further associated with a precision that relates to a granularity of the artifacts it contains. If, for example, the first corpus contains information related to each step of a restoration task, the precision of that corpus might specify that it contains information related to individual task steps. If the second corpus contains information related to estimating a cost of an entire restoration job, the precision of the second corpus might specify that the second corpus contains information associated with a complete restoration, rather than individual tasks of the restoration.

In some embodiments, each oracle, each artifact, and the cognitive system itself may each be associated with one or more distinguishable domains and precisions. Corpora of the car-restoration system, for example, may comprise an artifact that estimates costs, tools, replacement parts, and procedures needed to rebuild a carburetor on a 1957 Thunderbird. That artifact may thus be stored or linked to entries in several corpora and may be associated with the domains of each of those several corpora.

In step 203, the selection system identifies candidate oracles for each domain identified in step 201 and then retrieves artifacts associated with each oracle. The selection system might, for example, identify candidate oracles for a weather-forecasting cognitive system that include national weather-forecasting services, archives of historical climate and weather records, and news weathermen. The selection system might further identify for the car-restoration system candidate oracles that include recognized experts in specific models or years of cars, automobile manufacturers, classic-car publications, vintage-car sales forums, or organizers of touring car shows.

Oracles may be initially identified by means known in the art. These means may, for example, comprise functions of an oracle's public reputation, of a number or frequency of an publications, of an accuracy of predictions made by or based on artifacts associated with an oracle, or of a number of citations to an oracles publications.

Like step 201, this task may be performed by any means known in the art, such as by referring to recorded lists created by local experts or designers, by soliciting recommendations from users, or by using sophisticated methods of analytics or natural-language processing to infer oracle identifications from public records.

In some embodiments, the oracle-selection system may select and gather artifacts associated with each identified candidate oracle. This gathering may also be performed by means known in the art, such as by use of a web-crawler or “bot” agent that scours the Internet looking for relevant documents. In some embodiments, the selecting and gathering may be done by accessing previously prepared databases of information or by selecting from a predefined list extrinsic sources to search.

In most embodiments, step 203 is an enormously complex procedure that may retrieve many thousands of documents associated with dozens or hundreds of candidate oracles. In some embodiments, it may be is important that these retrieved artifacts are essentially contemporaneous in order to minimize a chance of retrieving artifacts that conflict with each other because they were created at different times. In such embodiments, the retrieval may be performed by a massively parallel mechanism that scours a huge number of online or offline sources, and that strives to retrieve documents that were last updated at times that are as similar as possible.

In some implementations, a web-crawling “bot” or other mechanism known in the art may populate a temporary repository with discovered artifacts. This repository may further identify a time at which each artifact was retrieved or a time at which each artifact was last updated. In such cases, the selection system in this step may automatically select a latest version of each artifact, or a subset of the temporarily stored artifacts that were last updated at a most similar time. In some cases, the selection system may select all artifacts stored in the temporary repository, and in such cases, the selection system may later assign higher ranks in step 209 to artifacts that have later creation, update, or retrieval times.

These documents may be in the process of being continuously updated (such as a weather forecast or event statistics), created, or deleted. Embodiments of this invention cannot operate without the speed and scope of one or more computerized systems that may be continuously or continually searching for, identifying, retrieving, and aggregating or organizing artifacts from a potentially enormous number of sources. Without this class of performance, embodiments of the present invention cannot reliably identify artifacts current enough to provide confidence to its results.

In step 205, the oracle-selection system automatically classifies the artifacts selected and retrieved in step 203. This classification may comprise associating each artifact with a domain, precision, corpus, or oracle. In some embodiments, the artifact may be associated with more than one domain, corpus, or oracle.

In some embodiments, this classification may be performed as a function of an oracle associated with the artifact. If, for example, an expert in restoration of early-1960s Mustangs writes a how-to article for an automotive magazine, that article may be associated with classifications that comprise one or more of“automotive restoration,” “1960s automobile restoration,” “Ford Mustang,” and “restoration techniques.”

In some embodiments, this classification may be performed or augmented by means of technologies associated with artificially intelligent or cognitive systems. For example, the oracle-selecting system may intelligently assign a domain of “1950s Chevrolet restoration costs” to an artifact that comprises a natural-language discussion of cost estimates for restoring automobiles that the system recognizes as Chevrolet models sold during the 1950s. Simpler embodiments might select a similar domain by a less-sophisticated keyword analysis that determines that the artifact comprises a higher occurrence of the words “restoration,” “dollars,” “Chevrolet,” and years falling between 1949 and 1960.

Artifacts may comprise natural-language documents, such as a news article, an opinion column, an online text, voice, or video conversation, or a transcription of spoken words. Many other types of structured and unstructured artifacts may be identified, such as historic records; tables of statistics; images, videos, and other media; and business documents. Some embodiments may comprise image-recognition or facial-recognition technologies, Web analytics, natural-language processing, or other types of software or systems capable of extracting information or meaning from unstructured data.

An artifact may be associated with an oracle because the oracle is the author of the artifact. But other types of associations are possible. An oracle may be associated with an artifact, for example, because the oracle published a book that cited information in that artifact or because the artifact is a magazine article that includes an interview with the oracle. If an oracle is an automobile manufacturer, sales figures, marketing literature, and recall notices may all qualify as artifacts to be associated with that oracle, even if those artifacts did not originate with the oracle itself.

The oracle-selection system then stores each classified artifact in one or more corpora that are either already associated with the artifact or that share a characteristic with the artifact. An artifact associated with domain “Avanti engine parts” might, for example, be stored in a corpus of domain “Studebaker” (the manufacturer that originally sold the Avanti automobile line), “engine parts,” “1960s automobiles,” “engine rebuilds,” or “replacement parts.”

In some embodiments, other characteristics of the artifact, such as a precision or an oracle, may be used instead or in combination with domain values in order to identify one or more best corpora to store the artifact.

Step 207 begins an iterative procedure of steps 207-221. Each iteration of this procedure further refin-es the information stored in the one or more corpora of the cognitive system. At the beginning of the first iteration, the corpora will have been seeded with the initial set of artifacts retrieved in step 205.

In step 209, the selection system ranks the artifacts stored in the one or more corpora in step 207 or in step 221. If an artifact has not already been associated with all the domains to which it may belong, that association is performed now.

The ranking is performed as a function of rules that ascribe relative importance and relevance of each artifact. Artifacts that comprise accurate predictions, for example, may be ranked higher (that is, given more importance) than artifacts that comprise predictions that did not come true. Similarly, artifacts that more closely address a topic associated with a domain might be ranked higher than those that are only peripherally related.

In one example, consider three artifacts that have been classified as being associated with a domain “Model T and Model A restoration/Costs.” A first artifact is a 1998 magazine article that quotes a hobbyist's estimate of his cost to restore a Ford Model T. A second artifact is a 2016 interview with a car-restoration expert who discusses current price trends of replacement parts for 1920s automobiles. The third artifact is a 2016 price catalog of after-market specialist automotive parts that includes some of the parts that may be used during a Model T restoration.

These three artifacts may be ranked by relevance in 2016, where the 1998 article is most closely relevant to the “Model T” subject matter of the domain because it directly addresses the topic of estimating a cost to restore a Ford Model T; the 2016 article, which discusses an entire decade of automobiles, is less relevant; and the price catalog is the least relevant because it does not comprehensively list all parts related to a Model T, contains much information unrelated to the domain, and does not provide information from which may be inferred general costs of the Model T parts it does not list. Based on relevance alone, therefore, the selection system in step 209 might rank the 1998 article first, the 2016 article second, and the price catalog third.

Because each cognitive system associated with an embodiment of the present invention may have different priorities and may be intended for different purposes or different types of users, each associated selection system may use different criteria to rank similar artifacts. A second embodiment associated with the above scenario may, for example, rank the 2016 article higher than it does the 1998 article because costs cited in the 2016 article may be deemed more relevant to current prices. Here, the second embodiment considers a smaller number of more accurate prices to have greater relevance to the domain than would a larger number of older prices.

When ranking artifacts in this step, embodiments of the present invention might also consider the likelihoods that each artifact's content may be used by the cognitive system to correctly predict a future outcome. Here, such a consideration may rank the catalog highest, despite the fact that it is incomplete, because the catalog cites real-world prices that are very likely to be accurate in the current year 2016. The 2016 article might be ranked second because it is so much more current than the 1998 article.

As with relevance considerations, the rules by which accuracy rankings may be determined are a function of implementation details. In embodiments that consider both relevance and accuracy when ranking artifacts, the weightings applied to each set of considerations may also be determined as a further function of implementation details. If, for example, a cognitive system is intended to answer very narrow, specific questions that seeks a quantitative answer, such as “How much will it cost to replace a rear wheel and axle on a 1923 Ford Model A?” then an associated selection system may place greater emphasis on accuracy than on relevance when ranking artifacts. If, however, the system requires less precision and is intended to answer more general questions like “Has the cost to restore a Model T Ford increased substantially over the last twenty years?,” then the selection system may have to infer an aggregate cost by current and historic pricing data and expert opinions that it extracts from a larger number of artifacts. In such an example, relevance would be more important than accuracy, since the accuracy of each extracted datum would have less of an effect on the aggregated total, but performance constraints might make it important for the system to limit the number of artifacts it evaluates to those that are most closely related to a selected domain.

Many other combinations of ranking methods are possible, but each embodiment that ranks artifacts in this step should strive to use a method that best satisfies its specific design requirements.

In step 211, the selection system assigns or updates a confidence factor to each candidate oracle. These confidence factors (sometimes referred to as “confidence values”) are determined as a function of the artifact classifications and ratings determined in step 209.

Consider, for example, a case in which a first oracle and a second oracle are each associated with one or more artifacts characterized by a domain “San Juan weather.” If the first oracle's artifacts, as a whole, are ranked more favorably than the artifacts produced or associated with the second oracle, then the first oracle might be assigned a confidence factor higher than that of the second oracle when working within the “San Juan weather” domain. That is, if a user asks the cognitive system, “Will it rain in San Juan this week?” the cognitive system in determining how best to predict the week's weather in San Juan in order to answer the question, will ascribe more value to artifacts of the first, higher-confidence, oracle than it does to artifacts of the second oracle.

As with artifact rankings, exact details of a method of assigning confidence factors may be implementation-dependent, and may comprise determining or referring to predefined weightings. In the current San Juan scenario, for example, an embodiment of the selection system might more heavily weigh rankings of artifacts that are derived from government agencies than it weighs rankings of local weather broadcasts. In another example, a system that is implemented by different designers might more heavily weigh locally derived, more precise artifacts than it does artifacts produced by broader regional sources.

As with the artifact rankings of step 211, confidence-value assignments may be updated periodically, frequently, or continuously, as a function of the selection system's ongoing receipt of new artifacts. One important aspect of embodiments of the present invention is that they must be able to constantly adjust rankings, weightings, confidence factors, and other metadata associated with their corpora in order to accommodate the ever-changing body of information from which corpus contents are derived. In some embodiments, similar adjustments will also be made dynamically and automatically in step 221 as a function of user interactions and feedback.

In step 213, contents of the artifacts and of the metadata associated with each artifact is indexed in order to facilitate its efficient selection and retrieval. As described above, this metadata may include a characteristic of an artifact, such as a source oracle, a domain or a precision. This indexing may be performed by means known in the art for creating a data structure of a database, an ontology, or knowledgebase, or of an other information repository of an artificially intelligent system containing information and logic that may be used by the system to infer meaning to unstructured content.

The indexing may conform to any format or method of organization known in the art, and may organize the stored artifacts and their metadata into any sort of organization that allows the stored information to be retrieved more efficiently. Embodiments of the present invention may select formatting or organizations as a function of the volume, type, frequency of update, and frequency of access of the stored information.

For example, a simpler system might tag each stored item with an alphanumeric title and then use those titles as a database index or other access mechanism that allows stored information to be searched, selected, and retrieved by means of an alphabetic sort.

Embodiments that comprise a large number of domains might index metadata by domain name to make domain-based retrievals more efficient and, similarly, embodiments that comprise artifacts retrieved from a large number of oracles, or where an artifact may be associated with multiple oracles, might employ an indexing scheme that allows selection and retrieval of an artifact as a function of an oracle associated with that artifact, or that allows artifacts and their metadata to be associated with an indexing data structure that comprises multiple oracles, possibly arranged in a hierarchy as a function of each oracle's confidence factor. Many other indexing methods are possible, and a selection of which methods are used may be based on implementation-dependent requirements or constraints.

In step 215, the selection system merges the artifacts and metadata indexed in step 213 into the cognitive system's one or more corpora. This merging may be performed by means known in the art for updating a corpus of an artificially intelligent system. In some embodiments, each merged artifact and element (or set) of metadata is stored in one or more of the cognitive system's corpora as a distinct indexed document, or as a data set that comprises two or more related, indexed documents.

At the conclusion of step 215, the cognizant system will have full access to information and logic stored in its one or more corpora in step 215. This stored information comprises artifacts and their associated metadata have been classified, ranked, and indexed by other steps of FIG. 2, and where the stored artifacts were retrieved from, or associated with, oracles that were assigned confidence factors in step 211 at least in part as a function of the classification and ranking of the artifacts.

In step 217, the cognitive system, during its normal interaction with users, receives a natural-language user communication that requests a predictive response. The system, by means known in the art, infers meaning to the natural-language user input and then identifies a prediction that it must make in order to respond to the user, makes that prediction, and then responds to the user.

In embodiments of the present invention described by FIG. 2, the cognitive system determines how to make its prediction by referring to information stored in its one or more corpora. When artifacts stored in the one or more corpora comprise conflicting information, the cognitive system or the selection system may use rankings, classifications, precision, and confidence factors associated with the artifacts to determine which is more likely to be correct.

For example, if a user asks “How much would it cost to rebuild a stock rear-exit exhaust system of a 1958 Dodge Silver Challenger?” the cognitive system might respond by searching for artifacts in all relevant domains. These domains might comprise “exhaust systems,” “1950s Dodge automobiles,” “Dodge Challenger,” “replacement parts/exhaust systems/rear-exit exhaust systems,” “replacement parts/exhaust systems/costs,” and “replacement parts/Dodge/1950s.”

A search through the one or more corpora might retrieve several thousand documents or data sets, some of which provide conflicting information. A vintage-car price guide, for example, might list a 1958 Challenger tailpipe segment as costing $675, while a discussion among Challenger enthusiasts posted on a social-network site might state that a poster's recent exhaust replacement for a “1950s Challenger” required a total of $500 in parts.

The cognizant system may then, as a function of benefits provided by the present invention, resolve this conflict by observing that the price guide artifact is ranked higher than the social-network discussion artifact, that the oracle identified by metadata of the price-guide artifact (a respected publisher of books about collectibles) has a higher confidence factor than does the online-service oracle identified by metadata of the social-network discussion artifact, and that the price guide has greater precision, listing costs of specific parts for specific models of car, than does the more general social-network discussion. In response to these observations, the cognizant system would then assign a higher probability of correctness to a prediction based on figures cited in the price guide than it would to a prediction based on the social-network discussion.

In some embodiments, this procedure would be further facilitated by weightings assigned to each artifact or element of metadata stored in the one or more corpora. In some embodiments, this procedure would be further facilitated by weightings assigned to each oracle associated with an artifact or element of metadata stored in the one or more corpora. In either case, the weighting would help the cognizant system more quickly determine which artifacts are most likely to lead to a correct prediction.

In step 219, the selection system receives, either directly or forwarded by the cognitive system, feedback about the accuracy of the prediction made to the user in step 217. This feedback may be received by means known in the art, such as by user input that identifies whether the prediction was later determined to be correct, by a user selection of a “Like” or “Dislike” button, a “star” rating, or by a user's natural-language comment, by whether the user trusts the prediction based on the user's personal knowledge, or by input from other users. In some embodiments, information received by means of any of these feedback mechanisms may be imported by the selection system as a new artifact that identifies the user as an oracle.

In some embodiments, the feedback may be a function of a receipt of additional artifacts. If, for example, the cognitive system responded to the user in step 217 with a weekend weather forecast for Las Vegas, Nev., then the feedback might comprise a report received the following week that describes the weather that actually occurred over that weekend.

In some embodiments, the system does not wait for user feedback before proceeding to step 221. In such cases, the selection system or the cognitive system merely determine whether feedback is available for the response presented to the user in the most recent iteration step 217, or whether feedback is available for an earlier response to a user. In such embodiments, if such feedback is identified, it is processed in this step as described above. If no such feedback is identified, the method of FIG. 2 continues to step 221.

In step 221, additional artifacts may be received from oracles that may be similar to the oracles from which artifacts were received in step 205 or in previous iterations of step 221. These additional artifacts may comprise further feedback about the cognitive system's predictive response of step 217. In some cases, these additional artifacts may result in an alteration to the list of oracles identified in step 203.

The cognitive system then updates its list of artifacts. In some cases, an artifact may be deleted from the list in response to the receiving new artifacts. If, for example, a revised list of weather events corrects typographical errors in a previous list, that previous list might be discarded upon receipt of the revised list.

At the conclusion of step 217, the selection system will have created an updated list of artifacts, oracles, and related metadata that conforms most closely to the most currently available documents. Because of the rapidly changing, dynamic nature of such tasks, this updating may occur frequently and rapidly. In real-world conditions, it may be necessary for each iteration of the iterative procedure of steps 207-217 to complete in a fraction of a second in order to ensure that the cognitive system's predictions take into account the most current available data, and to ensure that users do not perceive an undue delay in the system's response time.

The iterative procedure of steps 207-217 then repeat indefinitely, so long as the cognitive system continues to interact with uses. Each iteration processes the most current set of artifacts, oracles, and related information, merges that information and its metadata into the one or more corpora, uses that latest information to respond to a next user input, and then further updates its artifacts as a function of any feedback received about the response (or earlier response) and as a further function of adding artifacts to, revising artifacts currently comprised by, or deleting artifacts from the most recent previous aggregation of retrieved artifacts. Steps of FIG. 2 may be performed in some embodiments in a different order. Ranking, classification, and weighting of artifacts and assigning confidence factors to oracles may, for example, be performed in a different sequence. In all cases, however, a method of FIG. 2 will always use the ranking and classification systems identified above to select and assign importance to artifacts as a function of the weightings, classifications, confidence factors, and rankings identified and assigned to artifacts, oracles, and metadata according to general methods described above.

What is claimed is:

1. An oracle-selection system comprising a processor, a memory coupled to the processor, and a computer-readable hardware storage device coupled to the processor, the storage device containing program code configured to be run by the processor via the memory to implement a method for intelligent selection and classification of oracles, the method comprising:
the selection system identifying a set of candidate oracles, where each oracle of the set of candidate oracles is an expert in a field of endeavor identified by a domain of a corpus of a cognitive system;
the selection system retrieving a set of artifacts from remote sources, where each artifact of the set of artifacts comprises unstructured data associated with an oracle of the set of oracles, and where the retrieving is performed by a set of concurrent procedures that retrieve artifacts at a substantially similar time;
the selection system associating a subset of the retrieved artifacts with the domain, where the domain identifies a topic of each artifact of the subset;
the selection system assigning a confidence factor of a set of confidence factors to each oracle of the set of oracles, where a higher confidence factor assigned to a first oracle identifies a greater presumed degree of reliability of one or more predictions made by the first oracle within the field of endeavor;
the selection system ranking the subset of artifacts, where a higher-ranking artifact of the subset is deemed to have more significance to the cognitive system than does a lower-ranking artifact of the subset; and
the selection system merging the artifacts into the corpus.

2. The selection system of claim 1, where the cognitive system and the corpus are characterized by a system precision that identifies a degree of granularity of predictions made by the cognitive system in response to user input, and where the ranking further comprises:
the selection system assigning an artifact precision of a set of artifact precisions to each artifact of the subset; and
the selection system assigning a higher rank to an artifact associated with an artifact precision that is more similar to the system precision.

3. The selection system of claim 1, where the ranking further comprises:
the selection system assigning a higher rank to an artifact associated with an oracle assigned a higher confidence factor.

4. The selection system of claim 1, further comprising:
the selection system, in response to receiving a feedback about an accuracy of a prediction of a future event related to the domain made by the cognitive system as a function of the corpus, updating the corpus, where the updating comprises:
the selection system further retrieving an updated set of artifacts;
the selection system further associating an updated subset of the updated set of artifacts with the domain, where the domain identifies a topic of each artifact of the updated subset;
the selection system revising the set of confidence factors as a function of the updated set of artifacts;
the selection system further ranking the updated subset of artifacts; and
the selection system merging the updated subset of artifacts into the corpus such that the cognitive system's next prediction will be made as a function of the updated corpus.

5. The selection system of claim 1, where the retrieved artifacts each comprise one or more natural-language publications that either refer to or are produced by an oracle of the set of candidate oracles.

6. The selection system of claim 1, where the merging comprises:
the selection system indexing each artifact of the set of artifacts such that each index of the each artifact identifies a characteristic of the each indexed artifact;
the selection system creating entries in the corpus that each comprise information extracted from an artifact of the indexed artifacts; and
the selection system incorporating the indexes of the indexed artifacts into a data structure of the corpus such that created entries may be identified and retrieved by a corpus-access function of the cognitive system.

7. The selection system of claim 1, where the corpus comprises two or more sub-corpora, where each sub-corpus is associated with one or more sub-domains that are each distinct from the domain of the corpus, and where each oracle of the set of candidate oracles and each artifact merged into the corpus is associated with the domain and with one or more of the sub-domains.

8. A method for intelligent selection and classification of oracles, the method comprising:
a computerized oracle-selection system identifying a set of candidate oracles, where each oracle of the set of candidate oracles is an expert in a field of endeavor identified by a domain of a corpus of a cognitive system;
the selection system retrieving a set of artifacts from remote sources, where each artifact of the set of artifacts comprises unstructured data associated with an oracle of the set of oracles, and where the retrieving is performed by a set of concurrent procedures that retrieve artifacts at a substantially similar time;
the selection system associating a subset of the retrieved artifacts with the domain, where the domain identifies a topic of each artifact of the subset;
the selection system assigning a confidence factor of a set of confidence factors to each oracle of the set of oracles, where a higher confidence factor assigned to a first oracle identifies a greater presumed degree of reliability of one or more predictions made by the first oracle within the field of endeavor;
the selection system ranking the subset of artifacts, where a higher-ranking artifact of the subset is deemed to have more significance to the cognitive system than does a lower-ranking artifact of the subset; and
the selection system merging the artifacts into the corpus.

9. The method of claim 8, where the cognitive system and the corpus are characterized by a system precision that identifies a degree of granularity of predictions made by the cognitive system in response to user input, and where the ranking further comprises:
the selection system assigning an artifact precision of a set of artifact precisions to each artifact of the subset; and
the selection system assigning a higher rank to an artifact associated with an artifact precision that is more similar to the system precision.

10. The method of claim 8, where the ranking further comprises:
the selection system assigning a higher rank to an artifact associated with an oracle assigned a higher confidence factor.

11. The method of claim 8, further comprising:
the selection system, in response to receiving a feedback about an accuracy of a prediction of a future event related to the domain made by the cognitive system as a function of the corpus, updating the corpus, where the updating comprises:
the selection system further retrieving an updated set of artifacts;
the selection system further associating an updated subset of the updated set of artifacts with the domain, where the domain identifies a topic of each artifact of the updated subset;
the selection system revising the set of confidence factors as a function of the updated set of artifacts;
the selection system further ranking the updated subset of artifacts; and
the selection system merging the updated subset of artifacts into the corpus such that the cognitive system's next prediction will be made as a function of the updated corpus.

12. The method of claim 8, where the retrieved artifacts each comprise one or more natural-language publications that either refer to or are produced by an oracle of the set of candidate oracles.

13. The method of claim 8, where the merging comprises:
the selection system indexing each artifact of the set of artifacts such that each index of the each artifact identifies a characteristic of the each indexed artifact;
the selection system creating entries in the corpus that each comprise information extracted from an artifact of the indexed artifacts; and
the selection system incorporating the indexes of the indexed artifacts into a data structure of the corpus such that created entries may be identified and retrieved by a corpus-access function of the cognitive system.

14. The method of claim 8, further comprising providing at least one support service for at least one of creating, integrating, hosting, maintaining, and deploying computer-readable program code in the computer system, wherein the computer-readable program code in combination with the computer system is configured to implement the identifying, retrieving, associating, assigning, ranking, and merging.

15. A computer program product, comprising a computer-readable hardware storage device having a computer-readable program code stored therein, the program code configured to be executed by an oracle-selection system comprising a processor, a memory coupled to the processor, and a computer-readable hardware storage device coupled to the processor, the storage device containing program code configured to be run by the processor via the memory to implement a method for intelligent selection and classification of oracles, the method comprising:
the selection system identifying a set of candidate oracles, where each oracle of the set of candidate oracles is an expert in a field of endeavor identified by a domain of a corpus of a cognitive system;
the selection system retrieving a set of artifacts from remote sources, where each artifact of the set of artifacts comprises unstructured data associated with an oracle of the set of oracles, and where the retrieving is performed by a set of concurrent procedures that retrieve artifacts at a substantially similar time;
the selection system associating a subset of the retrieved artifacts with the domain, where the domain identifies a topic of each artifact of the subset;
the selection system assigning a confidence factor of a set of confidence factors to each oracle of the set of oracles, where a higher confidence factor assigned to a first oracle identifies a greater presumed degree of reliability of one or more predictions made by the first oracle within the field of endeavor;
the selection system ranking the subset of artifacts, where a higher-ranking artifact of the subset is deemed to have more significance to the cognitive system than does a lower-ranking artifact of the subset; and
the selection system merging the artifacts into the corpus.

16. The computer program product of claim 15, where the cognitive system and the corpus are characterized by a system precision that identifies a degree of granularity of predictions made by the cognitive system in response to user input, and where the ranking further comprises:
the selection system assigning an artifact precision of a set of artifact precisions to each artifact of the subset; and
the selection system assigning a higher rank to an artifact associated with an artifact precision that is more similar to the system precision.

17. The computer program product of claim 15, where the ranking further comprises:
the selection system assigning a higher rank to an artifact associated with an oracle assigned a higher confidence factor.

18. The computer program product of claim 15, further comprising:
the selection system, in response to receiving a feedback about an accuracy of a prediction of a future event related to the domain made by the cognitive system as a function of the corpus, updating the corpus, where the updating comprises:
the selection system further retrieving an updated set of artifacts;
the selection system further associating an updated subset of the updated set of artifacts with the domain, where the domain identifies a topic of each artifact of the updated subset;
the selection system revising the set of confidence factors as a function of the updated set of artifacts;
the selection system further ranking the updated subset of artifacts; and
the selection system merging the updated subset of artifacts into the corpus such that the cognitive system's next prediction will be made as a function of the updated corpus.

19. The computer program product of claim 15, where the retrieved artifacts each comprise one or more natural-language publications that either refer to or are produced by an oracle of the set of candidate oracles.

20. The computer program product of claim 15, where the merging comprises:
the selection system indexing each artifact of the set of artifacts such that each index of the each artifact identifies a characteristic of the each indexed artifact;
the selection system creating entries in the corpus that each comprise information extracted from an artifact of the indexed artifacts; and
the selection system incorporating the indexes of the indexed artifacts into a data structure of the corpus such that created entries may be identified and retrieved by a corpus-access function of the cognitive system.
